(19) United States
(12) Patent Application Publication
(10) Pub. No.: US 2026/0010348 A1
(43) Pub. Date: Jan. 8, 2026

(54) AUTOMATED APPLICATION ARCHITECTURE CREATION

(71) Applicants: American Express Travel Related Services Company, Inc., New York, NY (US); AMEX Canada, Inc., Toronto (CA)

(72) Inventors: Shoma Samir Chakravarty, Annapolis, MD (US); Srinivas V. Dasari, Scottsdale, AZ (US); Utsab Kayal, Phoenix, AZ (US); Alvin H. Kok, Toronto (CA); Michael Steven Zoratti, Hamilton (CA)

(21) Appl. No.: 18/765,029

(22) Filed: Jul. 5, 2024

(51) Int. Cl. G06F 8/20

(52) U.S. Cl. CPC G06F 8/20

(57) ABSTRACT

Disclosed are various embodiments for automating the creation of an application architecture. A description is received for an artifact in a first layer of a development framework. Then, a second set of artifacts in a second layer of the development framework is identified based at least in part on the artifact in the first layer of the development framework. Next, a prompt is generated that comprises the description for the artifact and the set of artifacts. Subsequently, the prompt is sent to a generative AI service.

### BACKGROUND

Application architecture design is often a time-consuming process. An initial vision or idea, which may be briefly articulated or described, first needs to be a high-level architecture that describes the necessary technical components. This high-level architecture often is further expanded in detail to described technical, operational, security, and data requirements and architectures.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an example of a development framework according to various embodiments of the present disclosure.

FIG. 2 is a drawing of a network environment according to various embodiments of the present disclosure.

FIG. 3 is a sequence diagram illustrating one example of functionality implemented as portions of an application executed in a computing environment in the network environment of FIG. 2 according to various embodiments of the present disclosure.

### DETAILED DESCRIPTION

Disclosed are various approaches for creating an application architecture using a development framework process. Due to the time involved with creating the application architecture manually, generative artificial intelligence can be used to create the development framework that documents the architecture of the application. The resulting development framework can then be used to build the application in an efficient manner. The reduction in time and resources spent developing enterprise applications can therefore be reduced, improving the efficiency of the software development process and reducing the resources used in the software development process.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

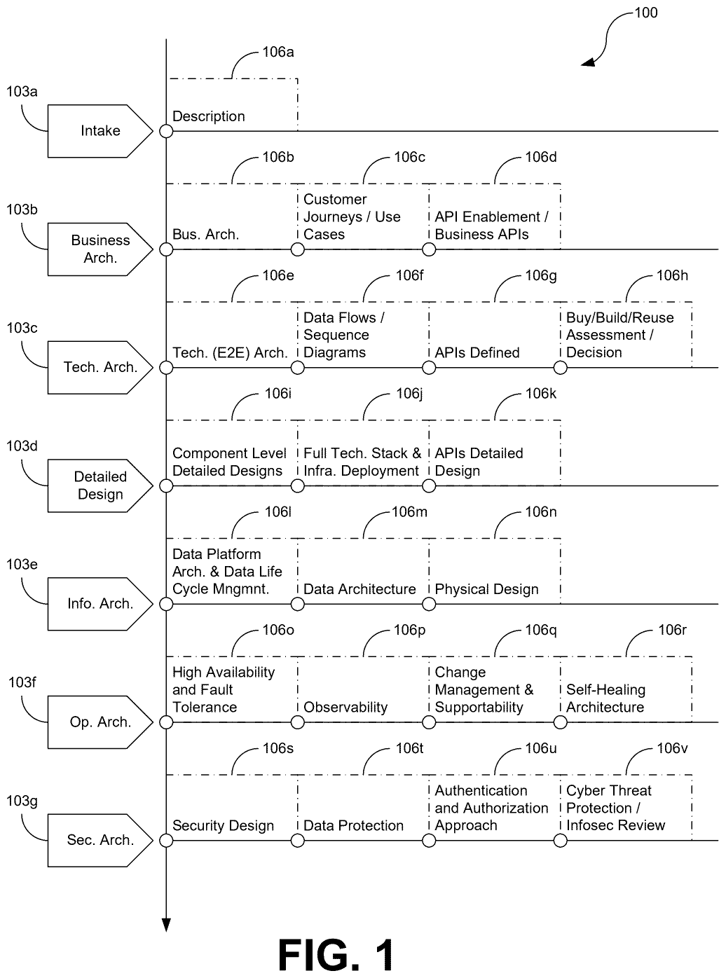

As illustrated in FIG. 1, depicts the organization of a development framework 100 according to various embodiments of the present disclosure. The development framework 100 can have one or more layers 103, such as layers 103a, 103b, 103c, 103d, 103e, 103f, and 103g (collectively “layers 103” and generically “layer 103”). Each layer can list one or more artifacts 106 associated with the layer 103. Each artifact 106 can represent a specification of information that is used or produced by a software development process or by deployment and operation of a system. Examples of artifacts can include models, source code files, documentation (e.g., in the form of a file, web page, etc.), database tables, scripts, etc.

The purpose of the intake layer 103a could be to provide or describe a high-level description of the application and its purpose without diving into much technical detail. For example, the intake layer 103a could have a single “description” artifact 106a. The description artifact 106a could act as the representation of the high-level description of the application and its purpose.

As another example, the business architecture layer 103b underneath the intake layer 103a could include a “business architecture” artifact 106b, a “customer journeys” or “use cases” artifact 106c, and an “application programming interface (API)” or “business API” artifact 106d. The purpose of the business architecture layer 103b could be to detail capabilities for the application described in the “description artifact 106a and how the capabilities could be implemented without committing to any particular technical solution or framework. Meanwhile, the customer journeys or use cases artifacts 106c could describe how the customer could use or interact with the application described in the description artifact 106a. For example, a mobile banking application could have customer journeys or use cases artifacts 106c that describe the use cases (e.g., check account balances, transfer funds, make payments) and the customer journey within the application (e.g., login, select account, etc.). Finally, the API enablement or business API artifacts 106 could represent a decision regarding whether API access would be allowed or permitted.

The third layer 103, the technical architecture layer 103c, could include one or more technical architecture or end-to-end artifacts 106e, one or more data flows or sequence diagram artifacts 106f, one or more API definitions artifacts 106g, and/or one or more decision artifacts 106h. The purpose of the technical architecture layer 103c could be to outline technology decisions that would enable the business architecture described by the business architecture layer 103b. The technical architecture or end-to-end artifacts 106e could represent a high-level schema or architecture of the components (e.g., applications, services, databases, etc.) that will be used to form the application. The data flows or sequence diagram artifacts 106f could represent high-level flow charts and/or sequence diagrams that depict the operations of individual components of the application, the interactions between components of the application, and the sequence or order of the operations depicted. The API definitions artifacts 106g could provide high-level representations of the APIs that will be made available by the application and the functionality provided by the APIs. The decision artifact 106h could represent a technical decision to buy, build, or reuse existing technical components or architectures that are available.

The fourth layer 103, the detailed design layer 103d, could include one or more component level detailed design artifacts 106i, a full technology and infrastructure deployment artifact 106j, and/or one or more API detailed design artifacts 106k. The purpose of the detailed design layer 103d could be to outline or specify how the technical decisions embodied by the technical architecture layer 103c could be implemented. Accordingly, the detailed design artifacts 106i could represent detailed descriptions of the components (e.g., applications, services, databases, etc.) that will be used to form the application. Moreover, the full technology and infrastructure deployment artifact 106j could represent a detailed list or description of the technologies and infrastructure to be used to develop the application. In addition, an API detailed design artifact 106k could represent a detailed description of the APIs that will be made available by the application, including the functions provided, the parameters to the functions, and the results returned by the functions of the APIs.

The fifth layer 103, the information architecture layer 103e, could include a data platform and data lifecycle management artifact 106l, a data architecture artifact 106m, and/or a physical design artifact 106n. The purpose of the information architecture layer 103e could be to outline or specify the decisions related to ensure the integrity of the data lifecycle based on the decisions made in the detailed design layer 103d, including how to ensure data privacy, data protection, data scalability, and high availability of data. The data platform and data lifecycle management artifact 106l could represent decisions made regarding where and how data will be stored and how data will be managed. This can include decisions regarding where and how data will be generated, collected, processed, stored, managed, analyzed, visualized, interpreted, shared, archived, and deleted. The data architecture artifact 106m could represent how data is to be structured and stored, such as data schemas for data structures or database tables. The physical design artifact 106n could represent decisions about the physical implementation of the application, including hardware requirements, hardware location (e.g., on-premises or hosted by a third-party cloud computing provider), and similar considerations.

The sixth layer 103, the operational architecture layer 103f, could include a high availability and fault tolerance artifact 1060, an observability artifact 106p, a change management and supportability artifact 106q, and/or a self-healing architecture artifact 106r. The purpose of the operational architecture layer 103f could be to document the approaches chosen to implement resilience, observability, supportability and self-healing of the application based on the decisions made in the previous layers 103, such as the detailed design layer 103d and the information architecture layer 103e. The high availability and fault tolerance artifact 1060 could represent design decisions to allow for high availability and fault tolerance (e.g., by implementing failover systems, redundant systems, etc.). The observability artifact 106p could represent design decisions related to how the operation of the application can be observed and/or monitored. The change management and supportability artifact 106q could represent change-control processes for supporting the application to be developed. The self-healing architecture artifact 106r could represent design decisions that allow for the application to be developed to correct errors or respond to outages rather than fail in response to errors or outages.

The seventh layer 103, the security architecture layer 103g, could include a security design artifact 106s, a data protection artifact 106t, an authentication and authorization approach artifact 106u, and/or a cyber threat protection/infosec review artifact 106v. The purpose of the security architecture layer 103g could be to describe authentication, authorization, data, and cyber protection approaches to secure the application based on the decisions made in the previous layers 103, such as the detailed design layer 103d, the information architecture layer 103e, and the operational architecture layer 103f. The security design artifact 106s could represent the security threats that the application is likely to face (e.g., the threat model) and the security controls that will be put in place to mitigate the security threats. The data protection artifact 106t could represent the approaches that will be used to protect the data accessed by, stored by, or processed by the application to be developed. The authentication and authorization approach artifact 106u could represent the approaches that will be used to authenticate and authorize users. The cyber threat protection/infosec review artifact 106v could represent notes or review of the application to be developed by security analysts.

Moreover, each layer 103 in the development framework 100 is dependent on at least one previous layer 103. For example, without a description artifact 106a that describes the application, one could not describe or define the business architecture of the application and, therefore, could not create an appropriate “business architecture” artifact 106b, a “customer journeys” or “use cases” artifact 106c, and an “application programming interface (API)” or “business API” artifact 106d. However, not every artifact 106 is required to be present in every layer. Large, complicated, projects that require detailed or extensive planning and documentation could have every artifact 106 in every layer 103 created as part of the planning and design process. Smaller projects that require less detailed or less extensive planning and documentation might only have a subset of the artifacts 106 or layers 103 created as part of the planning and design process.

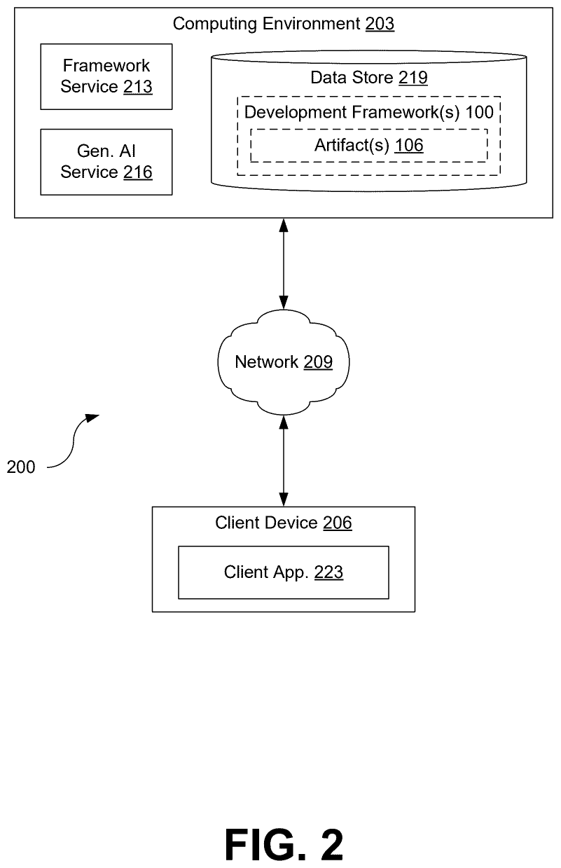

With reference to FIG. 2, shown is a network environment 200 according to various embodiments. The network environment 200 can include a computing environment 203, and a client device 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a framework service 213, a generative artificial intelligence (GenAI) service 216, and other applications, services, processes, systems, engines, or functionality not discussed in detail herein.

The framework service 213 can be executed to create, manage, and store development frameworks 100. In some instances, the framework service 213 could act as a front-end to the data store 219, thereby allowing a user to create, view, edit, and revise individual artifacts 106. In other instances, the framework service 213 could act as an intermediary to the GenAI service 216, collecting information from a user and then generating a prompt and sending the prompt to the GenAI service 216 to cause it create one or more artifacts 106 for a development framework 100.

The GenAI service 216 can be executed to receive prompts, processes the prompt, and returns a response to the prompts based on a model that has been trained. Accordingly, the GenAI service 216 could act as a front-end to the model. In some instances, the GenAI service 216 could provide a user interface (e.g., a web page) where the user could submit the prompt, which could be processed and forward to the model to generate a response. In other instances, the GenAI service 216 could provide an API which could be used to programmatically receive prompts and return responses. Examples of front-ends include OPENAI's CHATGPT®, OPENAI's API for enterprises, etc. Examples of GenAI models include large language models (LLMs), small language models (SLMs), text-to-image models (e.g., OPENAI's DALL-E 2®, GOOGLE BRAIN's IMAGEN®, etc.), and similar models. In some instances, the GenAI service 216 can be operated by the same entity that operates the framework service 213. In other instances, the GenAI service 216 could be operated by a third-party that offers GenAI software and/or platforms as a service (e.g., OPENAI®, GOOGLE®, etc.).

Also, various data is stored in a data store 219 that is accessible to the computing environment 203. The data store 219 can be representative of a plurality of data stores 219, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 219 is associated with the operation of the various applications or functional entities described below. This data can include one or more development frameworks 100, and potentially other data.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 206 or can be connected to the client device 206 through a wired or wireless connection.

The client device 206 can be configured to execute various applications such as a client application 223 or other applications. The client application 223 can be executed in a client device 206 to access network content served up by the computing environment 203 or other servers, thereby rendering a user interface on the display. To this end, the client application 223 can include a browser, a dedicated application, or other executable, and the user interface can include a web page, an application screen, or other user mechanism for obtaining user input. The client device 206 can be configured to execute applications beyond the client application 223 such as email applications, social networking applications, word processors, spreadsheets, or other applications.

Next, a general description of the operation of the various components of the network environment 200 is provided. Although the following description provides a simplified example of the operation of the various components and the interactions between them, other operations or interactions are also encompassed by the various embodiments of the present disclosure.

To begin, a user can decide that he or she wants to generate a new development framework 100 for a new application to be developed. Accordingly, the user can use the client application 223 of his or her client device 206 to connect to the framework service 213. The user can then use the client application 223 to submit a prompt to the framework service 213. The prompt could include, for example, a few sentences to a few paragraphs describing the application to be built, which could serve as a high-level description of the application and its purpose.

In response to receiving the prompt, the framework service 213 could begin the process of creating a development framework 100 for use for building the application. For example, the framework service 213 could generate a description artifact 106a for the intake layer 103a of the development framework and include the prompt to represent the high-level description of the application and its purpose.

The framework service 213 could then submit the description artifact 106a to the GenAI service 216 as part of a prompt for the GenAI service 216 to create the remaining layers 103 and artifacts 106 of the development framework 100 for the application to be built. In some instances, the framework service 213 could use prompt engineering or augmentation techniques to improve the quality of the response from the GenAI service 216. For example, the framework service 213 could use retrieval augmented generation (RAG) to improve the response from the GenAI service 216 by including one or more preexisting development frameworks 100 in the prompt submitted to the GenAI service 216. In some instances, the framework service 213 could include a predefined set of development frameworks 100 to include, or the framework service 213 could select a group or set of development frameworks 100 that have a highest ranking or highest score.

In response, the GenAI service 216 can generate a set of artifacts 106 for a set of layers 103. The GenAI service 216 can then return the generated set of artifacts 106 for the set of layers 103 to the framework service 213. The framework service 213 can then save the returned set of artifacts 106 for the set of layers 103, along with the description artifact 106a for the intake layer 103a created by the framework service 213 itself, as a new development framework 100. The framework service 213 can then return a response to the client application 223 to indicate that the new development framework 100 is available.

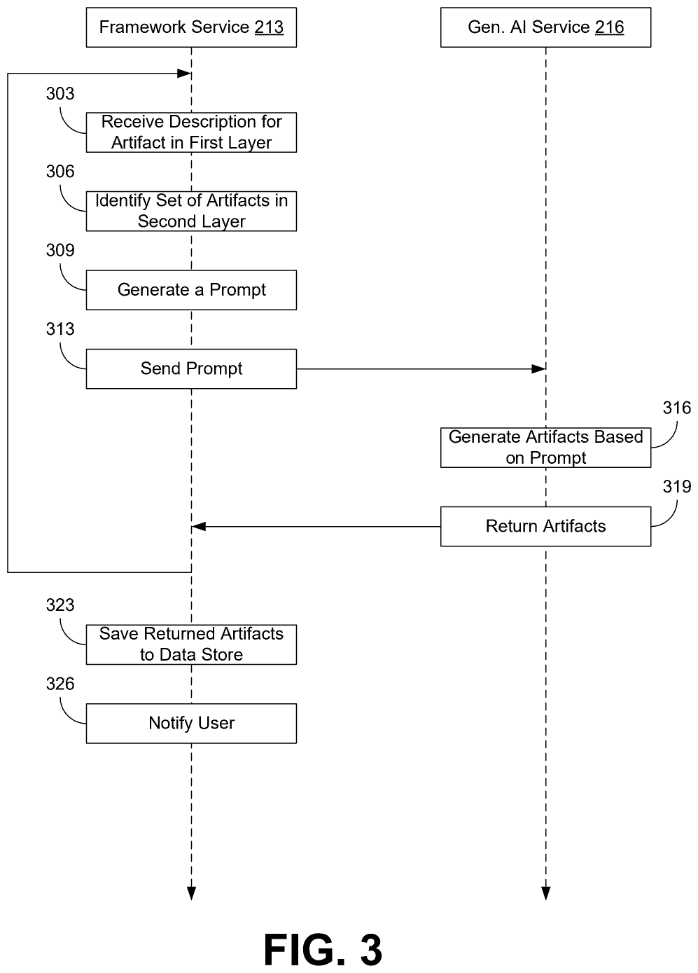

Referring next to FIG. 3, shown is a sequence diagram t that provides one example of the interactions between the framework service 213 and the GenAI service 216. The sequence diagram of FIG. 3 provides merely an example of the many different types of functional arrangements that can be employed to implement the operations of the depicted portions of the framework service 213 and the GenAI service 216. As an alternative, the sequence diagram of FIG. 3 can be viewed as depicting an example of elements of a method implemented within the network environment 200.

Beginning with block 303, the framework service 213 can receive a description for an artifact 106 in a layer 103 of a development framework 100. The description could specify the type of artifact 106 or layer 103 of the development framework 100 to provide additional context for the GenAI service 216 in subsequent blocks. This could happen in several scenarios.

For example, if a user decides that he or she wants to generate a new development framework 100, the user can use the client application 223 of his or her client device 206 to connect to the framework service 213. The user can then use the client application 223 to submit a description to the framework service 213. The description for the artifact 106 could include, for example, a few sentences to a few paragraphs describing the application to be built, which could serve as a high-level description of the application and its purpose. This could correspond to the description artifact 106a of the intake layer 103a. This example could then begin the process for automatically generating or creating an application architecture embodied by a new instance of a development framework 100. In this example, the user could specify that he or she wants a new development framework 100 to be created or provided some other indication that the provided description corresponds to the description artifact 106a of the intake layer 103a of a development framework 100. Alternatively, the framework service 213 could assume that the default artifact 106 and layer 103 for an input are the description artifact 106a of the intake layer 103a of a development framework 100.

As another example, an artifact 106 for a layer 103 of a development framework 100 could be provided to the framework service 213. This could occur, for example, when the output from the GenAI service 216 is to be chained to a subsequent input or prompt to the GenAI service 216. In this example, the type of artifact 106 and the type of layer 103 could be included with the artifact 106 provided.

Moving on to block 306, the framework service 213 can identify a set of artifacts 106 to be created for a layer 103 of the development framework 100. In some instances, the framework service 213 could specify all artifacts 106 and for all layers 103 below the layer 103 associated with the artifact 106 described in block 303. In other instances, the framework service 213 could specify one or more artifacts 106 for a second layer 103 immediately below the layer 103 associated with the artifact 106 described in block 303, such as when the output from the GenAI service 216 is to be chained to a subsequent input or prompt to the GenAI service 216.

Next, at block 309, the framework service 213 can generate a prompt for the GenAI service 216 to create additional artifacts 106 for a development framework 100. The prompt could specify, for example, the set of artifacts 106 identified at block 306. The prompt could also include one or more preexisting artifacts 106 from preexisting development frameworks 100 (e.g., for use with retrieval augmentation generation (RAG) approaches). For example, the framework service 213 could identify the same artifacts 106 from the same layer 103 in a predefined number of preexisting development frameworks 100. The individual ones of the predefined number of preexisting development frameworks 100 could be selected using various criteria. For example, the preexisting development frameworks 100 could be scored using various metrics or criteria, with the highest scored development frameworks 100 being included in the predefined number of development frameworks 100. As another example, individual artifacts 106 or individual layers 103 of the preexisting development frameworks 100 could be scored using various metrics or criteria, with the highest scored artifacts 106 (or the highest scored artifacts 106 in the highest scored layers 103) could be selected.

Then, at block 313, the framework service 213 can send the prompt generated at block 309 to the GenAI service 216. In some instances, the framework service 213 could invoke or call an API function provided by the GenAI service 216 and provide the prompt and any associated data as arguments to the API function.

Subsequently, at block 316, the GenAI service 216 can generate one or more artifacts 106 for one or more layers 103 based at least in part on the prompt generated at block 309. If the prompt included example artifacts 106, for individual layers 103, then the GenAI service 216 use the provided artifacts 106 to tailor the response artifacts 106 that it creates. For example, the GenAI service 216 could generate new artifacts that are similar to the artifacts 106 provided in the prompt (e.g., the same or similar type of artifacts, the same or similar writing or formatting style, the same or similar content, etc.). This could be done using retrieval augmentation generation (RAG) or similar techniques.

Moving on to block 319, the GenAI service 216 can return the artifacts 106 generated at block 316 to the framework service 213. For example, if the framework service 213 had made an API call at block 313, then the GenAI service 216 could return the artifacts 106 through a return or response to the API call.

Optionally, between blocks 319 and 323, the framework service 213 could take one or more of the artifacts 106 returned by the GenAI service 216 and provide it is as input to the framework service 213 at block 303. This could be done to generate artifacts 106 in a subsequent layer 103 of a development framework 100.

Proceeding to block 323, the framework service 213 can then store the artifacts 106 returned at block 319 in the data store 219. For example, the framework service 213 could create a new development framework 100 and save it to the data store 219. The framework service 213 could then create one or more layers 103 within the newly created development framework 100. The framework service 213 could then add the artifacts 106 returned at block 316 to the respective layers 103 of the newly created development framework 100.

Subsequently, at block 326, the framework service 213 could then notify the user who submitted the original description at block 303. For example, the framework service 213 could send a notification to the client application 223 executing on the client device 206 of the user. As another example, the framework service 213 could generate and send a web page to the client application 223 showing or presenting the newly created development framework 100, including the newly created layers 103 and artifacts 106.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a description for an artifact in a first layer of a development framework;
identify a set of artifacts in a second layer of the development framework based at least in part on the artifact in the first layer of the development framework;
generate a prompt comprising the description for the artifact and the set of artifacts; and
send the prompt to a generative AI service.

2. The system of claim 1, wherein the machine-readable instructions further cause the computing device to at least:
receive a result set of artifacts for the second layer of the development framework from the generative AI service; and
save the result set of artifacts to a data store.

3. The system of claim Error! Bookmark not defined., wherein the machine-readable instructions further cause the computing device to at least:
generate a second prompt comprising the description for the artifact and the result set of artifacts for the second layer of the development framework;
send the second prompt to the generative AI service;
receive a second result set of artifacts for a third layer of the development framework from the generative AI service; and
save the second result set of artifacts to the data store.

4. The system of claim Error! Bookmark not defined., wherein the machine-readable instructions further cause the computing device to at least notify a client application executing on a client device that result set of artifacts has been saved to the data store.

5. The system of claim 1, wherein each artifact in the set of artifacts represents a specification of information that is used or produced by a software development process.

6. The system of claim 5, wherein at least one artifact in the set of artifacts comprises a model, source code file, a documentation file, a database table, or a script.

7. The system of claim 1, wherein the generative AI service comprises a large language model.

8. A method, comprising:
receiving a description for an artifact in a first layer of a development framework;
identifying a set of artifacts in a second layer of the development framework based at least in part on the artifact in the first layer of the development framework;
generating a prompt comprising the description for the artifact and the set of artifacts; and
sending the prompt to a generative AI service.

9. The method of claim 8, further comprising:
receiving a result set of artifacts for the second layer of the development framework from the generative AI service; and
saving the result set of artifacts to a data store.

10. The method of claim Error! Bookmark not defined., further comprising:
generating a second prompt comprising the description for the artifact and the result set of artifacts for the second layer of the development framework;
sending the second prompt to the generative AI service;
receiving a second result set of artifacts for a third layer of the development framework from the generative AI service; and
saving the second result set of artifacts to the data store.

11. The method of claim Error! Bookmark not defined., further comprising notifying a client application executing on a client device that result set of artifacts has been saved to the data store.

12. The method of claim 8, wherein each artifact in the set of artifacts represents a specification of information that is used or produced by a software development process.

13. The method of claim Error! Bookmark not defined., wherein at least one artifact in the set of artifacts comprises a model, source code file, a documentation file, a database table, or a script.

14. The method of claim 8, wherein the generative AI service comprises a large language model.

15. A non-transitory, computer-readable medium, comprising machine-readable instructions that, when executed by a processor of a computing device, cause the computing device to at least:
receive a description for an artifact in a first layer of a development framework;
identify a set of artifacts in a second layer of the development framework based at least in part on the artifact in the first layer of the development framework;
generate a prompt comprising the description for the artifact and the set of artifacts; and
send the prompt to a generative AI service.

16. The non-transitory, computer-readable medium of claim 15, wherein the machine-readable instructions further cause the computing device to at least:
receive a result set of artifacts for the second layer of the development framework from the generative AI service; and
save the result set of artifacts to a data store.

17. The non-transitory, computer-readable medium of claim Error! Bookmark not defined., wherein the machine-readable instructions further cause the computing device to at least:
generate a second prompt comprising the description for the artifact and the result set of artifacts for the second layer of the development framework;
send the second prompt to the generative AI service;
receive a second result set of artifacts for a third layer of the development framework from the generative AI service; and
save the second result set of artifacts to the data store.

18. The non-transitory, computer-readable medium of claim Error! Bookmark not defined., wherein the machine-readable instructions further cause the computing device to at least notify a client application executing on a client device that result set of artifacts has been saved to the data store.

19. The non-transitory, computer-readable medium of claim 15, wherein each artifact in the set of artifacts represents a specification of information that is used or produced by a software development process.

20. The non-transitory, computer-readable medium of claim 15, wherein the generative AI service comprises a large language model.
